(19) United States
(12) Patent Application Publication
(10) Pub. No.: US 2019/0044841 A1
(43) Pub. Date: Feb. 7, 2019

(54) System and Method for Mapping Server Location based on Neighboring Server Racks

(71) Applicant: DELL PRODUCTS, LP, Round Rock, TX (US)

(72) Inventors: Jeffrey M. Lairsey, Round Rock, TX (US); Sajjad Ahmed, Austin, TX (US); Arulnambi Raju, Austin, TX (US); Minhaz Islam, Austin, TX (US)

(21) Appl. No.: 15/667,217

(22) Filed: Aug. 2, 2017

(51) Int. Cl. H04L 12/751; H04L 29/08; H04L 29/12; H04L 29/14; G01K 3/14; G06F 11/30

(52) U.S. Cl. CPC H04L 45/02; H04L 67/1004; H04L 61/1511; G06F 11/3452; G01K 3/14; G06F 11/301; G06F 11/3058; H04L 69/40

(57) ABSTRACT

A system includes a first server rack with a first wireless interface and a second server rack with a second wireless interface. The second server rack is in a first row of a data center with the first server rack. The first server rack establishes a first wireless link with the second server rack via the first and second wireless interfaces, determines a first value of a first received signal strength indication for the first wireless link, and determines that the second server is in the first row based upon the first value.

### FIELD OF THE DISCLOSURE

This disclosure generally relates to information handling systems, and more particularly relates to mapping server racks in a data center based upon neighboring server racks.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

A system may include a first server rack with a first wireless interface and a second server rack with a second wireless interface. The second server rack may be in a first row of a data center with the first server rack. The first server rack may establish a first wireless link with the second server rack via the first and second wireless interfaces, determine a first value of a first received signal strength indication for the first wireless link, and determine that the second server is in the first row based upon the first value.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating a generalized information handling system according to an embodiment of the present disclosure;

FIGS. 2-6 are block diagrams illustrating server racks within a data center according to an embodiment of the present disclosure; and

FIGS. 7 and 8 are block diagrams illustrating a data center according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

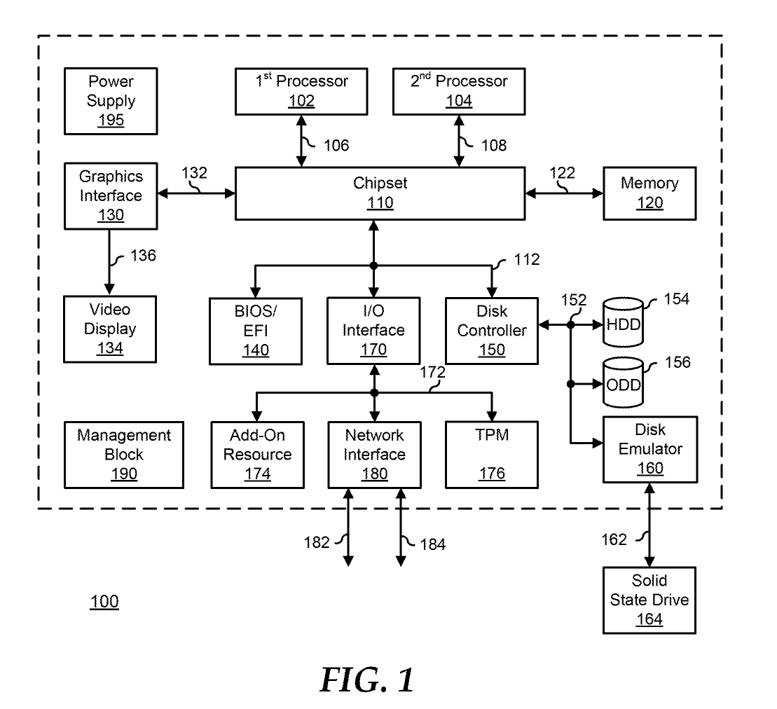

FIG. 1 illustrates a generalized embodiment of an information handling system 100. For purpose of this disclosure information handling system 100 can be configured to provide the features and to perform the functions of the OPF system as described herein. Information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 100 can include processing resources for executing machine-executable code, such as a central processing unit (CPU), a programmable logic array (PLA), an embedded device such as a System-on-a-Chip (SoC), or other control logic hardware. Information handling system 100 can also include one or more computer-readable medium for storing machine-executable code, such as software or data. Additional components of information handling system 100 can include one or more storage devices that can store machine-executable code, one or more communications ports for communicating with external devices, and various input and output (I/O) devices, such as a keyboard, a mouse, and a video display. Information handling system 100 can also include one or more buses operable to transmit information between the various hardware components.

Information handling system 100 can include devices or modules that embody one or more of the devices or modules described below, and operates to perform one or more of the methods described below. Information handling system 100 includes a processors 102 and 104, a chipset 110, a memory 120, a graphics interface 130, a basic input and output system/extensible firmware interface (BIOS/EFI) module 140, a disk controller 150, a hard disk drive (HDD) 154, an optical disk drive (ODD) 156, a disk emulator 160 connected to an external solid state drive (SSD) 162, an input/output (I/O) interface 170, one or more add-on resources 174, a trusted platform module (TPM) 176, a network interface 180, a management block 190, and a power supply 195. Processors 102 and 104, chipset 110, memory 120, graphics interface 130, BIOS/EFI module 140, disk controller 150, HDD 154, ODD 156, disk emulator 160, SSD 162, I/O interface 170, add-on resources 174, TPM 176, and network interface 180 operate together to provide a host environment of information handling system 100 that operates to provide the data processing functionality of the information handling system. The host environment operates to execute machine-executable code, including platform BIOS/EFI code, device firmware, operating system code, applications, programs, and the like, to perform the data processing tasks associated with information handling system 100.

In the host environment, processor 102 is connected to chipset 110 via processor interface 106, and processor 104 is connected to the chipset via processor interface 108. Memory 120 is connected to chipset 110 via a memory bus 122. Graphics interface 130 is connected to chipset 110 via a graphics interface 132, and provides a video display output 136 to a video display 134. In a particular embodiment, information handling system 100 includes separate memories that are dedicated to each of processors 102 and 104 via separate memory interfaces. An example of memory 120 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 140, disk controller 150, and I/O interface 170 are connected to chipset 110 via an I/O channel 112. An example of I/O channel 112 includes a Peripheral Component Interconnect (PCI) interface, a PCI-Extended (PCI-X) interface, a high speed PCI-Express (PCIe) interface, another industry standard or proprietary communication interface, or a combination thereof. Chipset 110 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/EFI module 140 includes BIOS/EFI code operable to detect resources within information handling system 100, to provide drivers for the resources, initialize the resources, and access the resources. BIOS/EFI module 140 includes code that operates to detect resources within information handling system 100, to provide drivers for the resources, to initialize the resources, and to access the resources.

Disk controller 150 includes a disk interface 152 that connects the disk controller to HDD 154, to ODD 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an IEEE 1394 (Firewire) interface, a proprietary interface, or a combination thereof. Alternatively, solid-state drive 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112, or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral channel 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board or add-in card disposed within information handling system 100, a device that is external to the information handling system, or a combination thereof.

Network interface 180 represents a NIC disposed within information handling system 100, on a main circuit board of the information handling system, integrated onto another component such as chipset 110, in another suitable location, or a combination thereof. Network interface device 180 includes network channels 182 and 184 that provide interfaces to devices that are external to information handling system 100. In a particular embodiment, network channels 182 and 184 are of a different type than peripheral channel 172 and network interface 180 translates information from a format suitable to the peripheral channel to a format suitable to external devices. An example of network channels 182 and 184 includes InfiniBand channels, Fibre Channel channels, Gigabit Ethernet channels, proprietary channel architectures, or a combination thereof. Network channels 182 and 184 can be connected to external network resources (not illustrated). The network resource can include another information handling system, a data storage system, another network, a grid management system, another suitable resource, or a combination thereof.

Management block 190 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 100. In particular, management block 190 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 100, such as system cooling fans and power supplies. Management block 190 can include a network connection to an external management system, and the management block can communicate with the management system to report status information for information handling system 100, to receive BIOS/UEFI or system firmware updates, or to perform other task for managing and controlling the operation of information handling system 100. Management block 190 can operate off of a separate power plane from the components of the host environment so that the management block receives power to manage information handling system 100 when the information handling system is otherwise shut down. An example of management block 190 may include a commercially available BMC product that operates in accordance with an Intelligent Platform Management Initiative (IPMI) specification, such as a Integrated Dell Remote Access Controller (iDRAC), or the like. Management block 190 may further include associated memory devices, logic devices, security devices, or the like, as needed or desired.

Power supply 195 represents one or more devices for power distribution to the components of information handling system 100. In particular, power supply 195 can include a main power supply that receives power from an input power source, such as a wall power outlet, a power strip, a battery, or another power source, as needed or desired. Here, power source 195 operates to convert the power at a first voltage level from the input power source to one or more power rails that are utilized by the components of information handling system. Power supply 195 can also include one or more voltage regulators (VRs) that each receive power from the main power supply and that operate to convert the input voltage to an output voltage that is used by one or more components of information handling system. For example, a VR can be provided for each of processors 102 and 104, and another VR can be provided for memory 120. Power supply 195 can be configured to provide a first power plane that provides power to the host environment, and to provide a second power plane that provides power to the management environment.

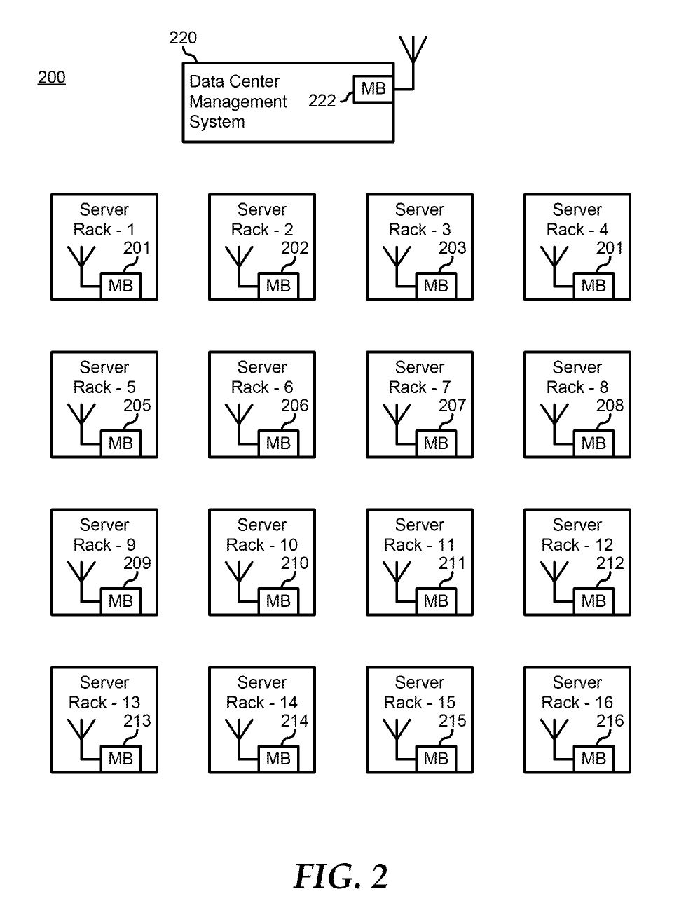

FIG. 2 illustrates a data center 200, including a data center management system 220 and a generic configuration of server racks. Data center 200 represents a collocated group of networked information handling systems utilized by an organization to provide remote storage, processing, and distribution of large amounts of data. In a particular embodiment, the information handling systems (hereinafter, “processing systems”) of data center 200 are networked together via a data backbone that provides high bandwidth communication paths between the processing systems to enable the storage, processing, and distribution of the data handled by the data center. The data backbone can be implemented as one or more network, communication, or storage fabrics, such as a Multi-Gigabit Ethernet, Fibre Channel or Fibre-Channel-Over-Ethernet (FCoE), Serial ATA, PCI-e, Serial Attached SCSI (SAS), or another stand-alone or hybrid fabric, as needed of desired.

In addition to the data backbone, the processing systems of data center 200 are networked together via a management network that provides for the OOB management of the respective processing systems of the data center, and each processing system includes one or more management block similar to management block 190. In a particular embodiment, the management network is provided in data center 200 as a network similar to the data backbone, but that is separate from the data backbone. In another embodiment, the management network is provided in data center 200 by the data backbone, but where the management network traffic is isolated from the data traffic of the host processing system of the processing systems of the data center. Here, the management traffic can be isolated by establishing a virtual private network (VPN) between the management blocks over the data backbone.

Additionally, whether the management network is provided by a separate network, or is provided as isolated network traffic on the data backbone, data center 200 is configured to provide the management network wirelessly. Here, the management blocks associated with each server rack of data center 200 includes a wireless communication interface that permits the server racks to communicate with each other outside of the management network, and to permit a user of a mobile device to connect to the management block of the associated server rack to gain management access to the functions and features of the management block. As such, the wireless communication interface represents a wireless data communication interface for short-range wireless communications. For example, the wireless communication interface may include a wireless data communication interface for establishing a Personal Area Network (PAN), such as a Near-Field Communication (NFC) interface, a Bluetooth interface, a Bluetooth-Low Energy (Bluetooth-LE) interface, or the like, or for establishing a Wireless Local Area Network (WLAN), such as a WiFi or 802.11 interface or the like, or another wireless interface.

Data center management system 220 represents one or more information handling system that is connected to the management network, and provides a centralized user interface for directing and controlling the various management functions and features of the management system, such as the retrieval of information related to the operation of the processing systems located in the server racks of data center 200, the provision of BIOS/UEFI or system firmware updates, the management of non-processing components of processing systems of the data center, such as system cooling fans and power supplies, and the maintenance of a processing system map of the data center. Data center management system 220 includes a management block 222 with a wireless communication interface, as indicated by an antenna symbol connected to the management block. Here, management block 222 is similar to management block 190 less in terms of the management capabilities being utilized to manage data center management system 220 itself, but in terms of its ability to participate in the management network, and to maintain the processing system map, as described further, below.

The server of data center 200 represent standardized frames for mounting the processing systems of the data center. Exemplary server racks 230 include standard frames for mounting processing systems in accordance with an Electronic Industries Alliance specification EIA-310-D, Cabinets, Racks, Panels, and Associated Equipment. As such, the server racks can be 24 inches wide, 40 inches deep, and can vary in height from 48-84 inches or more, and can accommodate the mounting of equipment that has a front panel that is 19 inches wide. Further, the equipment mounted in the server racks can be configured with front panel heights that are defined in terms of a rack unit (U) of 1.75 inches. That is, equipment that is 2 inches high is referred to as “1U” equipment, equipment that is 4 inches high is referred to as “2U” equipment, and so on. Further, the server racks can define locations within the server racks for mounting equipment in terms of rack units (U). For example, a lowermost mounting location in the server racks can be designated as “U1,” a next lowermost mounting location in the server racks can be designated as “U2,” and so on. Other examples of standardized frames can include a European Telecommunications Standards Institute (ETSI) standard ETS 300 119, a Western Electric standard 23 inch frame, an Open Rack mounting system in accordance with an Open Compute Project, or another standardized frame, as needed or desired.

The server racks each include a management block similar to management block 190 for providing a node to provide management functions for the processing systems of the server racks, as needed or desired. Typically, one or more of the processing systems of the server racks will include a management block. In another embodiment, one or more of the server racks includes a management block on its own behalf, in addition to any other management blocks of the processing systems in each server rack. In either case, one of the management blocks in each server rack is designated as the management block associated with the server rack. Where the server rack does not include its own management block, a particular one of the processing systems may be designated as the management block for the server rack. For example, where each server rack includes a ToR switch with a management block, the ToR switch may be designated as the management block for the server rack. On the other hand, where the server racks include their own management blocks, the associated management block may be designated as the management block for the associated server rack. Further, a combination of server rack management blocks and processing system management blocks may be designated for the various server racks, as needed or desired. For the purposes of this disclosure, references to communications with a server rack will be understood to be with whichever management block of the server rack is designated as described above.

As such, the server racks of data center 200 are each designated by the associated management block, and reference to communications with a management block shall be deemed to be equivalent to communications with the associated server rack. Thus data center includes server racks 1-16 that are each associated with a respective management block 201-216, each with a wireless communication interface. As such, the server racks may equivalently be designated by reference to their associated management block. For example, server rack—1 may equivalently be referred to as server rack 201, etc. The wireless communication interfaces can be in accordance with one or more wireless communication standards for short range wireless communications, such as a wireless local-area network (WLAN), a personal area network (PAN), or another short range wireless networking interface, such as a 802.11 (WiFi) interface, a Bluetooth or Bluetooth-Low-Energy (Bluetooth-LE) interface, or another WLAN or PAN wireless communication standard, as needed or desired.

Management blocks 201-216 are each configured to utilize their wireless communication interfaces to identify the other management blocks that are within range of their wireless communication interfaces. Then management blocks 201-216 categorize the other management blocks in terms of the received signal strength from the wireless communication interfaces of the other management blocks to estimate the locations of the other server racks with respect to each other. In particular, management blocks 201-216 operate to determine possible mappings of the server racks of data center 200. Management blocks 201-216 then aggregate their estimations to create a mapping of server racks in data center 200. In this way, the mapping of the server racks in data center 200 can be automatically done by management blocks 201-216. If the aggregation of the estimations result in two or more possible mappings, then management blocks 201-216 may operate to provide the possible mappings to data center management system 220, where a data center administrator selects the correct mapping for the server racks in data center 200. In this way, a more accurate mapping may be derived than would be the case without invoking human input to resolve possible conflicts. Further, when a new server rack is installed in data center 200, or an existing server rack is removed from the data center, the remapping of the server racks in the data center can be automatically performed.

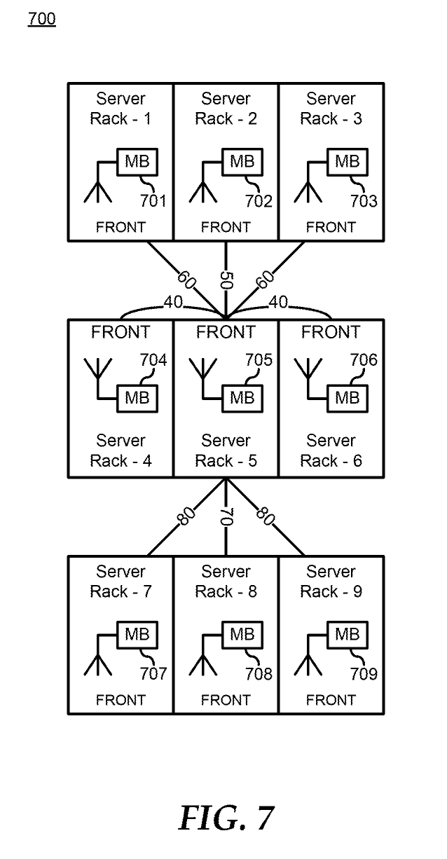

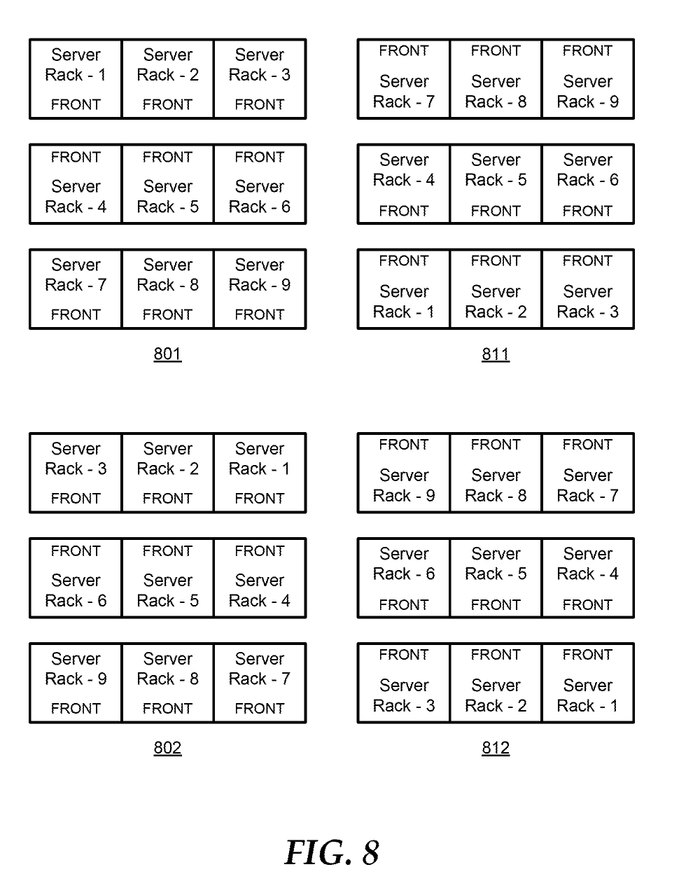

In particular, each of management blocks 201-216 participate in a process to derive the locations of the server racks of data center 200. In describing the process, it will be assumed that the server racks are all placed at equal distances from each other and are all oriented in a common direction. As such, a communication link established between any two management blocks located in a same row or in a same aisle, that is, an adjacent pair of management blocks, will exhibit the same received signal strength indications (RSSIs) from each other as a communication link established between any other two adjacent management blocks. Similarly, a communication link established between a first management block located in a first row and a first aisle and a second management block located in a next row and a next aisle, that is, a diagonally adjacent pair of management blocks, will exhibit the same RSSIs from each other as a communication link established between any other two diagonally adjacent management blocks. Further, the RSSIs for adjacent management blocks will be understood to be at a higher level than the RSSIs for diagonally adjacent management blocks because the distance between the adjacent management blocks is less than the distance between the diagonally adjacent management blocks. It will be understood that, for a typical data center, the above assumptions will not hold true. However, the arrangement of a typical data center permits several simplifying features of the three-step process that will be described with respect to FIGS. 7 and 8, below.

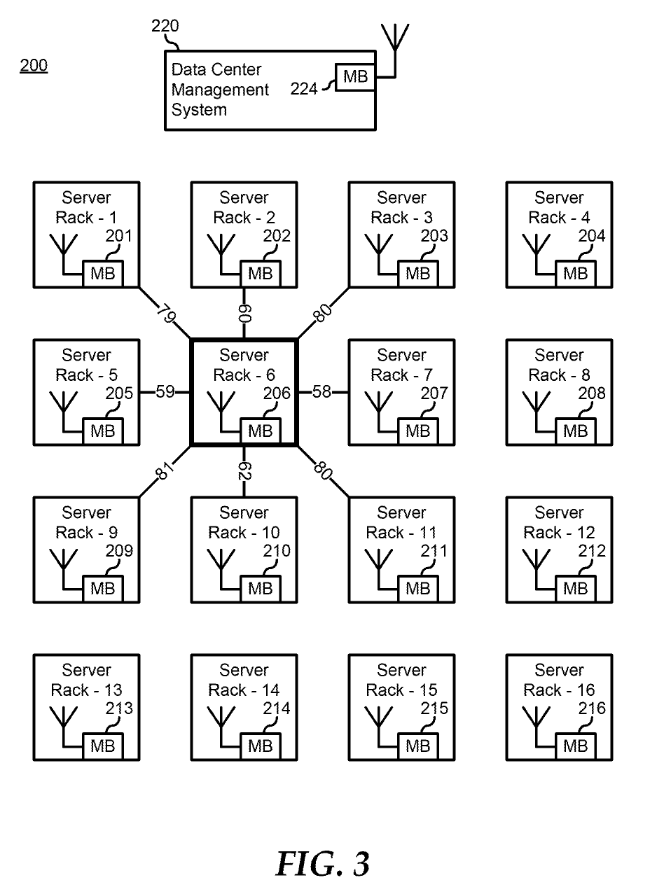

In a first step, information aggregation, each of management blocks 201-216 receives and aggregates information from each other management block that is within range of its wireless communication interface, for example, within 50 inches. For example, management block 206 may form wireless communication links with each of management blocks 201, 202, 203, 205, 207, 209, 210, and 211, as shown in FIG. 3. The numbers illustrated in the connections represent RSSI values in negative decibels (−x dBi), however, it will be understood that other measures of RSSI values may be utilized, as needed or desired. The information received by management block 206 includes a RSSI for each other management block. In addition, the information may include an identifier of the server rack associated with each other management block, including the types of processing systems located therein, a unique identifier (UID) of the server rack or the processing systems, a product and serial number, or the like. In a particular embodiment, each of management blocks 201-216 samples the RSSI for each of the other management blocks that are with range, and averages the RSSI to increase the locational accuracy for each of the other management blocks.

In a next step, neighbor server rack identification, each of management blocks 201-216 consolidates the received information to identify adjacent server racks and diagonally adjacent server racks based upon the received information from the connected server racks. Here, management block 206 makes an assumption that it is located in an unknown row, X, and in an unknown row, Y. Then, based just upon the RSSI information received by management block 206, the management block has learned that management blocks 202, 205, 207, and 210 are adjacent management blocks, that an unknown two of these management blocks are in a same row, X, and that the other unknown two of these management blocks are in a same aisle, Y. Not knowing a row or aisle affiliation for any of management blocks 202, 205, 207, or 210, management block 206 then makes an assumption and ascribes a row and aisle affiliation to any one of the adjacent management blocks. For example, management block 206 can make an assumption that management block 202 is in the same aisle, Y, and is in a neighboring row, X−1.

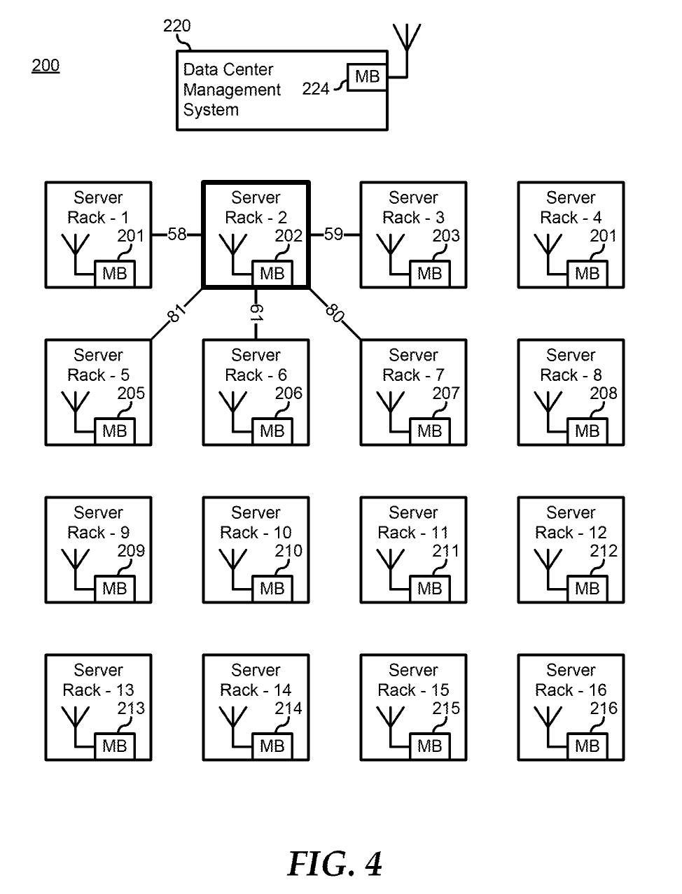

In a final step, data center mapping, the products of step 1, information aggregation, and step 2, neighbor rack identification, are combined to create a set of complete data center maps. As such, management block 202 may have formed wireless communication links with each of management blocks 201, 203, 205, 206, and 207, as shown in FIG. 4. Here, management block 202 has learned, in step 2, that management blocks 201, 203, and 206 are adjacent management blocks, that management block 202 is an edge block (because it only has 3 adjacent neighbor management blocks). Then, management block 202 having been ascribed as being in row X−1, and aisle Y, by management block 206 in step 2, management blocks 202 and 206 can determine: 1) that row X−1 includes management blocks 201, 202, and 203 (because management blocks 201 and 203 are adjacent to management block 202, but are diagonally adjacent to management block 206), 2) that row X includes management blocks 205, 206, and 207 (because management blocks 205 and 207 are adjacent to management block 206, but are diagonally adjacent to management block 202), 3) that aisle Y includes management blocks 202, 206, and 210 (because management block 210 is adjacent to management block 206, but is not connected to management block 202, or, alternatively, because management blocks 205 and 207 have been determined to be in row X, and management block 202 has been determined to be in aisle Y, leaving management block 210 as the second management block in the common aisle with management block 206), and 4) that row X+1 includes management blocks 209, 210, and 211. Further, management blocks 202 and 206 can determine that management blocks 201, 203, 205, 207, 209, and 211 are not in aisle Y, but can not determine more than that. As such, management block 206 then makes another assumption and ascribes an aisle affiliation to one of management blocks 205 and 207. For example, management block 206 can make an assumption that management block 205 is a neighboring aisle, Y−1.

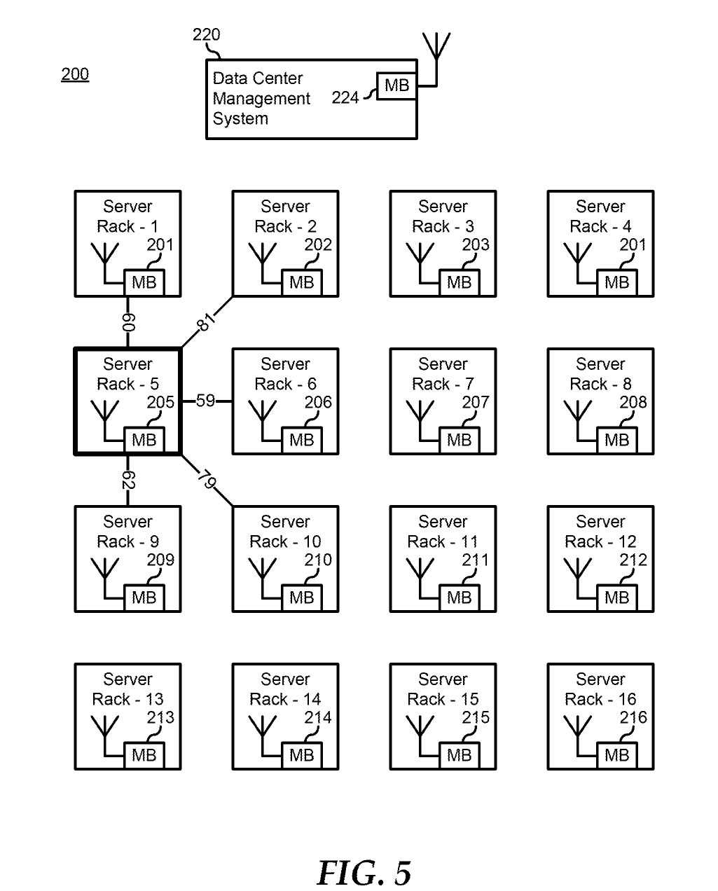

As such, management block 205 may have formed wireless communication links with each of management blocks 201, 202, 206, 209, and 210, as shown in FIG. 5. Here, management block 205 has learned, in step 2, that management blocks 201, 206, and 209 are adjacent management blocks, that management block 205 is an edge block (because it only has 3 adjacent neighbor management blocks). Then, in a next iteration of the final step, data center mapping, and management block 205 having been ascribed as being in aisle Y−1, by management block 206, management blocks 202, 205, and 206 can further determine: 1) that aisle Y−1 includes management blocks 201, 205, and 209, and 2) that aisle Y+1 includes management blocks 203, 207, and 211.

The third step, data center mapping, is repeated until it is determined that: row X−1 includes management blocks 201, 202, 203, and 204; row X includes management blocks 205, 206, 207, and 208; row X+1 includes management blocks 209, 210, 211, and 212; and row X+2 includes management blocks 213, 214, 215, and 216. Similarly, it is determined that: aisle Y−1 includes management blocks 201, 205, 209, and 213; aisle Y includes management blocks 202, 206, 210, and 214; aisle Y+1 includes management blocks 203, 207, 211, and 215; and aisle Y+2 includes management blocks 204, 208, 212, and 216.

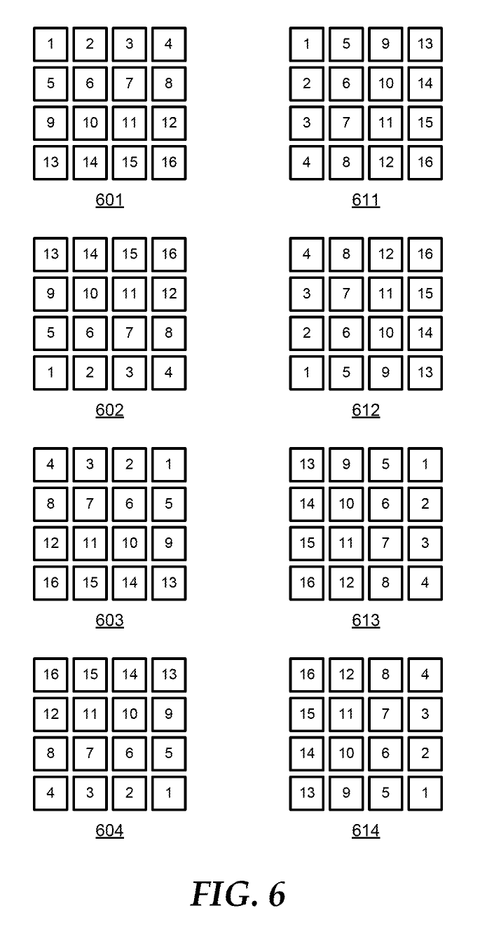

Note that the data center mapping, as described above, resulted from a set of assumptions, namely that management block 206 was located in row X and in aisle Y. Further, the data center mapping described above included several unstated assumptions. In particular, it was assumed that management bock 206 was located in a leftward and upward location in the data center, as depicted by the data center map 601 of FIG. 6. However, the mapping process could, given the same information collected in step 1, have yielded different data center maps if the starting location of management block 206 were located in a different location. For example, data center map 602 results if management block 206 is in a leftward and downward location, data center map 603 results if management block 206 is in a rightward and upward location, and data center map 604 results if management block 206 is in a rightward and downward location. Described logically, data center map 601 represents a base row/base aisle mapping, data center map 602 represents an inverted row/base aisle mapping, data center map 603 represents a base row/inverted aisle mapping, and data center map 604 represents an inverted row/inverted aisle mapping. Further, in the data center mapping described above, it was assumed that rows ran horizontally, and aisles ran vertically. Data center maps 611-614 represent equivalent mappings for the cases described for data center maps 601-604, but with the row and aisle orientations inverted.

Therefore, the data center mapping process described above reduces the set of possible maps from a very large number of possible maps to a very manageable number (eight) of maps. Here, after the eight maps are generated, one of management blocks 201-216 sends the eight maps to data center management system 220. Data center management system 220 then presents the eight possible maps to a data center administrator to select the correct map, based upon their knowledge of the particular layout of data center 200. In another embodiment, the eight maps can be further reduced to a single data center map by providing a particular management block with information related to the actual location of the particular management block and the orientation of the rows and aisles of the data center. Note that a case may arise where a particular row of server racks may be absent or unpopulated. In this case, the mapping as described above may operate to provide two maps of separated halves of the data center. Here, as above, a data center administrator may provide input to link the halves to form a complete map of the data center.

As noted above, a data center is not typically configured as described above with respect to FIGS. 2-6. As such, FIGS. 7 and 8 illustrate a data center 700 that has a more typical configuration. Here, the server racks are depicted as having a more rectangular outline, and are placed directly adjacent to each other. Moreover, the rows are configured such that a first row and a second row are oriented with the front faces of the server racks facing each other, and such that the second row and a third row are oriented with the back faces of the server racks facing each other. Further, the antennas for the wireless communication interfaces may be located near the front faces of the associated server racks. Here, nine server racks are located in three rows. The server racks each include respective management blocks 701-709. In an example of a configuration for the server racks of data center 700, each server rack is 24 inches wide, and 40 inches deep, and the aisles between the rows of server racks are 50 inches across. As such, the RSSI for any two adjacent server racks will be based upon the 24 inch distance between server racks, the RSSI for any two server racks directly across a face-to-face aisle will be based upon the 50 inch distance between the server racks, and the RSSI for any two server racks diagonally across a face-to-face aisle will be based upon the approximately 64 inch distance between the server racks. Similarly, the RSSI for any two server racks directly across a back-to-back aisle will be based upon the 130 inch distance between the server racks (50 inch aisle plus the depth of the two server racks: 50+(2×40)=130), and the RSSI for any two server racks diagonally across a back-to-back aisle will be based upon the approximately 136 inch distance between the server racks.

Management blocks 701-709 are each configured to utilize their wireless communication interfaces to identify the other management blocks that are within range of their wireless communication interfaces. Then management blocks 701-709 categorize the other management blocks in terms of the received signal strength from the wireless communication interfaces of the other management blocks to estimate the locations of the other server racks with respect to each other. In particular, management blocks 701-709 operate to determine possible mappings of the server racks of data center 700. Management blocks 701-709 then aggregate their estimations to create a mapping of server racks in data center 700. If the aggregation of the estimations result in two or more possible mappings, then management blocks 701-709 operate to provide the possible mappings to a data center management system, where a data center administrator selects the correct mapping for the server racks in data center 700. In this way, the mapping of the server racks in data center 700 can be automatically done by management blocks 701-709, without invoking human input except as may be needed to resolve possible conflicts. Further, when a new server rack is installed in data center 700, or an existing server rack is removed from the data center, the remapping of the server racks in the data center can be automatically performed.

In particular, each of management blocks 701-709 participate in a process to derive the locations of the server racks of data center 700. In the typical arrangement of data center 700, the communication link established between any two management blocks will exhibit a characteristic RSSI value based upon whether the server racks are in a same row, are situated directly front-to-front to each other, are situated diagonally front-to-front to each other, are situated directly back-to-back to each other, or are situated diagonally back-to-back to each other.

In a first step, information aggregation, each of management blocks 701-709 receives and aggregates information from each other management block that is within range of its wireless communication interface. For example, management block 705 may form wireless communication links with each of management blocks 701, 702, 703, 705, 706, 707, 708, and 709, as shown in FIG. 7. The information received by management block 206 includes a RSSI for each other management block. In addition, the information may include an identifier of the server rack associated with each other management block, including the types of processing systems located therein, a unique identifier (UID) of the server rack or the processing systems, a product and serial number, or the like. In a particular embodiment, each of management blocks 201-216 samples the RSSI for each of the other management blocks that are with range, and averages the RSSI to increase the locational accuracy for each of the other management blocks.

Here, as a result of the first step, information aggregation, management block 206 knows, based upon the RSSI values for the wireless communication links, that a row X includes itself and management blocks 704 and 706, that a row X−1 includes management blocks 701, 702, and 703, and that a row X+1 includes management blocks 707, 708, and 709. Management block 206 further knows, based upon the RSSI values for the wireless communication links, that a column Y includes itself and management blocks 702 and 708, that a column Y−1 includes management block 704 and two of management blocks 701, 703, 707, and 709, and that a column Y+1 includes management block 706 and the other two of management blocks 701, 703, 707, and 709. However, by sharing information with one of management blocks 704 and 706, the question as to which management blocks are in column Y−1, and which management blocks are in column Y+1, can be resolved. For example, management block 704 knows that column Y−1, that is, its own column, includes itself and management blocks 701 and 707. By sharing this information with management block 705, management block 705 can then infer that column Y+1 includes management blocks 703, 706, and 709.

The sharing of information between the management blocks is then sufficient to complete the data center mapping. However, here again, the data center mapping includes several assumptions. However, as can be seen in FIG. 8, the set of possible data center maps is reduced from eight to four. Here, a data center map 801 assumes that the server rack associated with management block 705 has a front face that is facing upwards, and that the server rack associated with management block 704 is to a right side of the server rack associated with management block 705. However, the mapping process could have yielded a data center map 802 where the server rack associated with management block 705 has a front face that is facing upwards, and that the server rack associated with management block 706 is to a right side of the server rack associated with management block 705, or a data center map 803 where the server rack associated with management block 705 has a front face that is facing downwards, and that the server rack associated with management block 704 is to a right side of the server rack associated with management block 705, or a data center map 804 where the server rack associated with management block 705 has a front face that is facing downwards, and that the server rack associated with management block 706 is to a right side of the server rack associated with management block 705.

Therefore, the data center mapping process described above reduces the set of possible maps from a very large number of possible maps to a very manageable number (four) of maps. Here, after the four maps are generated, one of management blocks 701-709 sends the eight maps to a data center management system. The data center management system then presents the four possible maps to a data center administrator to select the correct map, based upon their knowledge of the particular layout of data center 700. In another embodiment, the four maps can be further reduced to a single data center map by providing a particular management block with information related to the actual location of the particular management block and the orientation of the server rack associated with the management block.

Note that, in the above illustrated examples, only a single layer of adjacency was shown. However, it will be understood that a particular wireless communication interface may have a range that extends further to two or more server racks away. However, it will be further understood that the RSSIs of the wireless communication links for such further server racks will have correspondingly lower values, and so consideration of greater layers of adjacency will function to improve the accuracy of the resulting mappings. Thus, while not explicitly described herein, it should be understood that such extensions to the present disclosure are included herein.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A system, comprising:
a first server rack including a first wireless interface; and
a second server rack including a second wireless interface, wherein the second server rack is in a first row of a data center with the first server rack;
the first server rack configured to:
establish a first wireless link with the second server rack via the first and second wireless interfaces;
determine a first value of a first received signal strength indication for the first wireless link; and
determine that the second server is in the first row based upon the first value.

2. The system of claim 1, further comprising:
a third server rack including a third wireless interface, the third server rack in a second row of the data center, and directly across a first aisle between the first and second rows from the first server rack, the first and third server racks oriented in a face-to-face configuration;
the first server rack further configured to:
establish a second wireless link with the third server rack via the first and third wireless interfaces;
determine a second value of a second received signal strength indication for the second wireless link, wherein the second value is less than the first value; and
determine that the third server is in the second row, that the first and third server racks are oriented in the face-to-face configuration, and that the first and third server racks are in a first column of the data center based upon the second value.

3. The system of claim 2, further comprising:
a fourth server rack including a fourth wireless interface, the fourth server rack in the second row and directly across the first aisle from the second server rack, the second and fourth server racks oriented in the face-to-face configuration; and
the first server rack further configured to:
establish a third wireless link with the fourth server rack via the first and fourth wireless interfaces;
determine a third value of a third received signal strength indication for the third wireless link, wherein the third value is less than the second value;
receive first information from the second server rack via the first wireless link that the fourth server rack is in the second row; and
determine that the second and fourth server racks are oriented in the face-to-face configuration, and that the second and fourth server racks are in a second column of the data center based upon the third value and upon the first information.

4. The system of claim 3, further comprising:
a fifth server rack including a fifth wireless interface, the fifth server rack in a third row of the data center, and directly across a second aisle between the first and third rows from the first server rack, the first and fifth server racks oriented in a back-to-back configuration;
the first server rack further configured to:
establish a fourth wireless link with the fifth server rack via the first and fifth wireless interfaces;
determine a fourth value of a fourth received signal strength indication for the fourth wireless link, wherein the fourth value is less than the third value; and
determine that the fifth server is in the third row, that the first and fifth server racks are oriented in the back-to-back configuration, and that the fifth server rack is in the first column based upon the fourth value.

5. The system of claim 4, further comprising:
a sixth server rack including a sixth wireless interface, the sixth server rack in the third row and directly across the second aisle from the second server rack, the second and sixth server racks oriented in the back-to-back configuration; and
the first server rack further configured to:
establish a fifth wireless link with the sixth server rack via the first and sixth wireless interfaces;
determine a fifth value of a third received signal strength indication for the fifth wireless link, wherein the fifth value is less than the fourth value;
receive second information from the second server rack via the first wireless communication link that the sixth server is in the third row; and
determine that the second and sixth server racks are oriented in the face-to-face configuration, and that the sixth server is in a second column based upon the fifth value and upon the second information.

6. The system of claim 1, further comprising:
a data center management system;
the first server rack further configured to:
determine a first data center map showing the first and second server racks in the first row and showing the second server rack to a first side of the first server rack;
determine a second data center map showing the first and second server racks in the first row and showing the second server rack to a second side of the first server rack; and
provide the first and second data center maps to the data center management system.

7. The system of claim 6, wherein the first server rack is further configured to:
receive an indication from the data center management system to apply one of the first or the second data center maps; and
apply the indicated one of the first or second data center maps.

8. The system of claim 1, wherein the first and second wireless interfaces include Bluetooth-Low Energy interfaces.

9. A method, comprising:
establishing, between a first wireless interface of a first server rack and a second wireless interface of a second server rack, a first wireless link, wherein the second server rack is in a first row of a data center with the first server rack;
determining a first value of a first received signal strength indication for the first wireless link; and
determining that the second server is in the first row based upon the first value.

10. The method of claim 9, further comprising:
establishing, between the first wireless interface and a third wireless interface of a third server rack of the data center, a second wireless link, wherein the third server rack is in a second row of the data center, and directly across a first aisle between the first and second rows from the first server rack, the first and third server racks oriented in a face-to-face configuration;
determining, by the first server rack, a second value of a second received signal strength indication for the second wireless link, wherein the second value is less than the first value; and
determining, by the first server rack, that the third server is in the second row, that the first and third server racks are oriented in the face-to-face configuration, and that the first and third server racks are in a first column of the data center based upon the second value.

11. The method of claim 10, further comprising:
establishing, between the first wireless interface and a fourth wireless interface of a fourth server rack of the data center, a third wireless link, wherein the fourth server rack is in the second row and directly across the first aisle from the second server rack, the second and fourth server racks oriented in the face-to-face configuration;
determining, by the first server rack, a third value of a third received signal strength indication for the third wireless link, wherein the third value is less than the second value;
receiving, by the first server rack, first information from the second server rack via the first wireless link that the fourth server rack is in the second row; and
determining, by the first server rack, that the second and fourth server racks are oriented in the face-to-face configuration, and that the second and fourth server racks are in a second column of the data center based upon the third value and upon the first information.

12. The method of claim 11, further comprising:
establishing, between the first wireless interface and a fifth wireless interface of a fifth server rack of the data center, a fourth wireless link, wherein the fifth server rack is in a third row of the data center, and directly across a second aisle between the first and third rows from the first server rack, the first and fifth server racks oriented in a back-to-back configuration;
determining, by the first server rack, a fourth value of a fourth received signal strength indication for the fourth wireless link, wherein the fourth value is less than the third value; and
determining, by the first server rack, that the fifth server is in the third row, that the first and fifth server racks are oriented in the back-to-back configuration, and that the fifth server rack is in the first column based upon the fourth value.

13. The method of claim 12, further comprising:
establishing, between the first wireless interface and a sixth wireless interface of a sixth server rack of the data center, a fifth wireless link, wherein the sixth server rack is in the third row and directly across the second aisle from the second server rack, the second and sixth server racks oriented in the back-to-back configuration;
determining, by the first server rack, a fifth value of a third received signal strength indication for the fifth wireless link, wherein the fifth value is less than the fourth value;
receiving, by the first server rack, second information from the second server rack via the first wireless communication link that the sixth server is in the third row; and
determining, by the first server rack, that the second and sixth server racks are oriented in the face-to-face configuration, and that the sixth server is in a second column based upon the fifth value and upon the second information.

14. The method of claim 9, further comprising:
determining, by the first server rack, a first data center map showing the first and second server racks in the first row and showing the second server rack to a first side of the first server rack;
determining, by the first server rack, a second data center map showing the first and second server racks in the first row and showing the second server rack to a second side of the first server rack; and
providing, by the first server rack, the first and second data center maps to a data center management system of the data center.

15. A server rack, comprising:
a first wireless interface; and
a processor configured to:
establish a first wireless link with a second server rack via the first wireless interface and a second wireless interface of the second server rack, wherein the second server rack is in a first row of a data center with the first server rack;
determine a first value of a first received signal strength indication for the first wireless link; and
determine that the second server is in the first row based upon the first value.

16. The server rack of claim 15, the processor further configured to:
establish a second wireless link with the a third server rack via the first wireless interface and a third wireless interface of the third server rack, wherein the third server rack in a second row of the data center, and directly across a first aisle between the first and second rows from the first server rack, the first and third server racks oriented in a face-to-face configuration;
determine a second value of a second received signal strength indication for the second wireless link, wherein the second value is less than the first value; and
determine that the third server is in the second row, that the first and third server racks are oriented in the face-to-face configuration, and that the first and third server racks are in a first column of the data center based upon the second value.

17. The server rack of claim 16, the processor further configured to:
establish a third wireless link with the a fourth server rack via the first wireless interface and a fourth wireless interface of the fourth server, wherein the fourth server rack in the second row and directly across the first aisle from the second server rack, the second and fourth server racks oriented in the face-to-face configuration;
determine a third value of a third received signal strength indication for the third wireless link, wherein the third value is less than the second value;
receive first information from the second server rack via the first wireless link that the fourth server rack is in the second row; and
determine that the second and fourth server racks are oriented in the face-to-face configuration, and that the second and fourth server racks are in a second column of the data center based upon the third value and upon the first information.

18. The server rack of claim 17, the processor further configured to:
establish a fourth wireless link with a fifth server rack via the first wireless interface and a fifth wireless interface of the fifth server rack, wherein the fifth server rack in a third row of the data center, and directly across a second aisle between the first and third rows from the first server rack, the first and fifth server racks oriented in a back-to-back configuration;
determine a fourth value of a fourth received signal strength indication for the fourth wireless link, wherein the fourth value is less than the third value; and
determine that the fifth server is in the third row, that the first and fifth server racks are oriented in the back-to-back configuration, and that the fifth server rack is in the first column based upon the fourth value.

19. The server rack of claim 18, the processor further configured to:
establish a fifth wireless link with a sixth server rack via the first wireless interface and a sixth wireless interface of the sixth server rack, wherein the sixth server rack in the third row and directly across the second aisle from the second server rack, the second and sixth server racks oriented in the back-to-back configuration;
determine a fifth value of a third received signal strength indication for the fifth wireless link, wherein the fifth value is less than the fourth value;
receive second information from the second server rack via the first wireless communication link that the sixth server is in the third row; and
determine that the second and sixth server racks are oriented in the face-to-face configuration, and that the sixth server is in a second column based upon the fifth value and upon the second information.

20. The server rack of claim 19, the processor further configured to:
determine a first data center map showing the first and second server racks in the first row and showing the second server rack to a first side of the first server rack;
determine a second data center map showing the first and second server racks in the first row and showing the second server rack to a second side of the first server rack; and
provide the first and second data center maps to a data center management system.
